(19) United States
(12) Patent Application Publication
(10) Pub. No.: US 2010/0155443 A1
(43) Pub. Date: Jun. 24, 2010

(54) UTILITY CARRIER APPARATUS FOR MOTORCYCLES

(76) Inventor: Timothy Lasater, McKinney, TX (US)

Correspondence Address: VAN OPHEM & VANOPHEM, PC;REMY J VANOPHEM, PC, 51543 VAN DYKE, SHELBY TOWNSHIP, MI, 48316-4447, US

(21) Appl. No.: 12/342,536

(22) Filed: Dec. 23, 2008

(51) Int. Cl. B62J 9/00

(52) U.S. Cl. 224/448

(57) ABSTRACT

A utility carrier for removable attachment to a motorcycle. Has a spaced, downwardly extending pair of wheels that do not engage the ground or other surface when carried on the motorcycle, but permit the carrier to be used as a hand-operable cart after removal of the carrier from the motorcycle. The carrier is made up of a plurality of extending annular members with a plurality of horizontally extending support members that extend between sides of the annular members. Vertically extending members interconnect the annular members to form a rigid structure therewith. A forward portion of the carrier is provided with a two-piece vertically extending member, having an upper element received in a lower element. The lower element has an attached brace extending downwardly and outwardly from the lower element to permit the bearing plate that is attached to the brace to be removably attached to a complemental bearing plate that is a part of a hitch of the motorcycle.

### CROSS-REFERENCES TO RELATED APPLICATIONS

Not applicable.

### FEDERALLY SPONSORED RESEARCH OR DEVELOPMENT

Not applicable.

### REFERENCE TO A MICROFICHE APPENDIX

Not applicable.

### FIELD OF THE INVENTION

This invention relates to a wheeled carrier for detachable attachment to a vehicle. More particularly, this invention relates to a utility carrier of the aforesaid character that is well suited for attachment to and conveyance by a motorcycle and it does not contact the ground in service. Even more particularly, this invention relates to a carrier of the aforesaid character that is capable of functioning as a wheeled utility cart when detached from the motorcycle.

### BACKGROUND OF THE INVENTION

Patrin, U.S. Pat. No. 4,809,891 discloses a luggage rack for attachment to the rear of a motorcycle. While the luggage rack of this prior art reference does not contact the ground when it is attached to a motorcycle, it is not capable of functioning as a wheeled utility cart when detached from the motorcycle.

Dula, U.S. Pat. No. 5,738,261 discloses a wheeled hand truck that is attached to a vehicle hitch which is less complex and less expensive than prior art devices. The hand truck being at an elevation above the ground when so attached and maintains the attachment during transport. A foot release allows the operator to remove the hand truck from the hitch for use thereof The illustrated vehicle of this reference is a conventional pick-up truck, however, and not a motorcycle.

Cummins, U.S. Pat. No. 6,164,896 discloses a wheeled trash container lifting and transporting device that is attached to a rear bumper of a vehicle. The container being at an elevation above the ground when so attached. The illustrated vehicle of this reference is also a pick-up truck, however, and not a motorcycle. Accordingly, what is needed is a wheeled utility carrier attachable to a vehicle hitch of a motorcycle which can easily be removed therefrom and used as a wheeled utility cart.

### BRIEF DESCRIPTION OF THE INVENTION

A utility carrier according to the present invention consisting of a wheeled utility cart that is well suited for detachable attachment to a motor vehicle, especially to a motorcycle hitch. The carrier according to the present invention is designed to be carried entirely out of contact with the ground during movement of the motorcycle, to thereby avoid interfering with the steering of the vehicle during traveling. Preferably, the carrier is equipped with an opposed pair of wheels and a handle, which is preferably detachable from the carrier, to permit the carrier to function as a utility hand cart, the wheels, nonetheless, also being out of contact with the ground during traveling.

For use in detachable attachment to a motorcycle, the carrier is preferably a tubular construction to minimize weight, and it is equipped with a two-piece telescopic vertical member, a lower element of which can remain attached to the motorcycle hitch, the upper member of which can readily be disengaged therefrom, and reengaged to, the lower member, to permit the carrier to be used independently from the motorcycle hitch to which it is attached. The carrier of the present invention can also be equipped with a rearwardly facing stop and turn signal lights that can be disconnectedly wired into the vehicle's electrical system, and it can also be provided with a rearwardly facing license plate holder if necessary.

Accordingly, it is an object of the present invention to provide an improved utility carrier. More particularly, it is an object of the present invention to provide a utility carrier that is well suited for removable attachment to a motorcycle hitch.

It is a further object of the invention to provide a convenient and easy to use carrier which can easily be transported by a motorcycle and detached therefrom to utilize as a shopping cart and to provide for storage and transportation of packaged goods obtained during shopping by way of a motorcycle.

It is still a further object of the invention to provide a carrier which can easily and quickly be attached or detached from a conventional motorcycle hitch.

It is still a further object of the invention to provide a carrier for a motorcycle using a simple hitch which does not require any alteration of the motorcycle by which it is carried.

It is yet a further object of the invention to provide a carrier for a motorcycle which is easily detachable from the motorcycle hitch so that the carrier can be detached from the hitch and stored in a hotel room while traveling on the road.

For a further understanding of the present invention, attention is directed to the drawings and the following brief description thereof, to the detailed description of the invention and to the appended claims.

### BRIEF DESCRIPTION OF THE SEVERAL VIEWS OF THE DRAWINGS

FIG. 1 is a perspective view of a utility carrier according to a preferred embodiment of the present invention;

FIG. 2 is a side view of the utility carrier of FIG. 1 mounted to a motorcycle using a standard trailer hitch;

FIGS. 3 and 4 are side elevation views of the utility carrier of FIG. 1 after it is detached from the trailer hitch and at different positions in its operation as a rolling cart;

FIG. 5 is an elevation view of the utility carrier of FIG. 1 showing it's disengagement from the vertical post member by which it is attached to a motorcycle; and

FIG. 6 is a perspective view showing the attachment of the components for the utility carrier of FIGS. 1-5 to the motorcycle of FIG. 2.

### DETAILED DESCRIPTION OF THE PREFERRED EMBODIMENT OF THE INVENTION

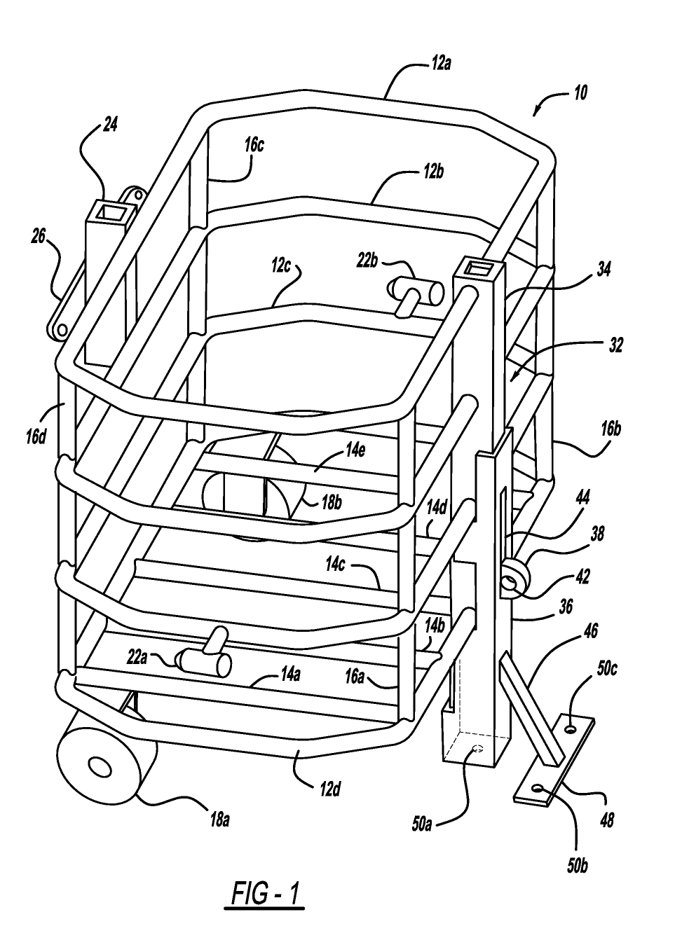

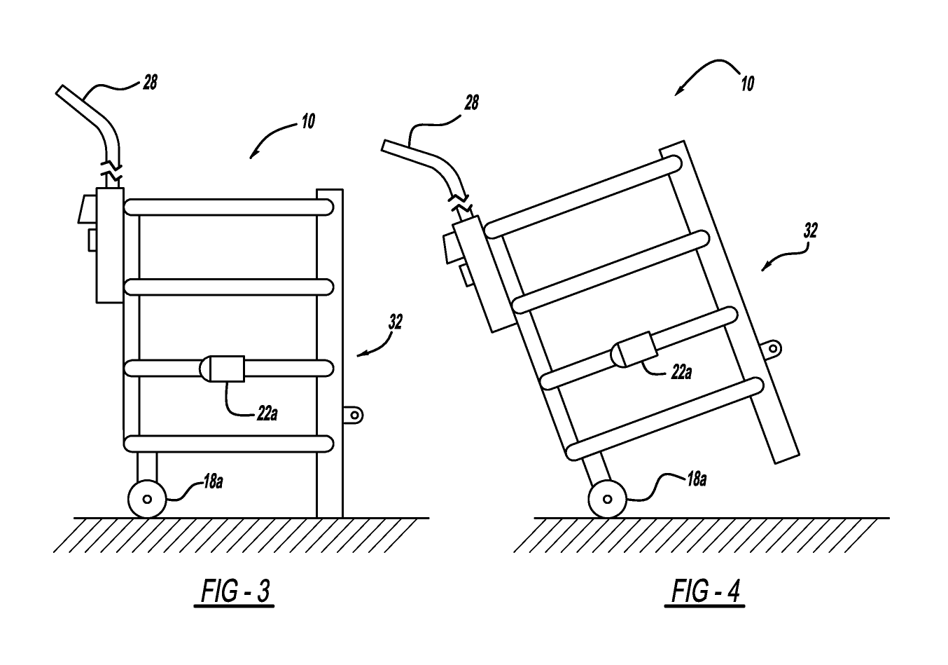

As is shown in FIGS. 1-5, a utility carrier or cart of the present invention is generally indicated by reference numeral 10, and the utility carrier 10 is constructed of a plurality of horizontally extending and vertically spaced annular tubular members 12a-12d that define the outermost extent of the utility cart 10. The utility carrier 10 also includes a plurality of horizontally extending and horizontally spaced tubular support members 14a-14e that extend between spaced sides of the lowermost annular tubular member 12d, and horizontally spaced and vertically extending support members 16a-16d that are secured to and connect the horizontally extending and vertically spaced annular tubular members 12a-12d in a rigid upright structure. As illustrated in FIG. 1, the utility carrier 10 is shown as being completely open at its top and substantially open at its sides and bottom for minimum weight. A person skilled in the art will quickly recognize that the distances between the tubular structure and support members can be constructed to choice depending on what type of materials and/or goods one wishes to carry in the utility carrier 10. Alternatively, a relatively light weight plastic sheet liner may be fit to the inside of the utility carrier 10 to prevent any articles carried within the utility carrier 10 from falling out between the spaced tubular structure. Of course, if desired, the utility carrier 10 can be provided with walls around its sides and at its bottom, and with an openable cover, none of which is shown, to protect any goods being carried in the utility carrier 10 from being exposed to the environment. In any case, the utility carrier 10 is provided with an opposed pair of spaced wheels 18a-18b that depend from the lower most horizontally extending and vertically spaced annular tubular member 12d, at a location at or near the rear of the utility carrier 10, to permit the utility carrier 10 to be used as a cart after removal from the motorcycle vehicle, as shown, for example, in FIGS. 3 and 4. The utility carrier 10 is also provided with rearwardly facing lights 22a-22b that are attached to any of the horizontally extending and vertically spaced annular tubular members 12a-12d, shown as the annular tubular member 12c, to function as stop or turn signal lights, this function requiring that the rearwardly facing lights 22a, 22b be disengageably interconnected to the electrical system of the associated vehicle by means well known in the prior art, not shown.

The utility carrier 10 is also provided, at its rear or wheeled end, with a vertically extending annular member 24 that extends between the horizontally extending and vertically spaced annular tubular members 12a and 12b. The vertically extending annular member 24 is provided with a horizontally extending bracket 26 to which a license plate, not shown, may be attached and a handle 28, as shown in FIGS. 3, 4 and 5. The handle 28 is removably inserted into the vertically extending annular member 24 to permit the utility carrier 10 to function as a hand-operable cart after removal from the motorcycle hitch.

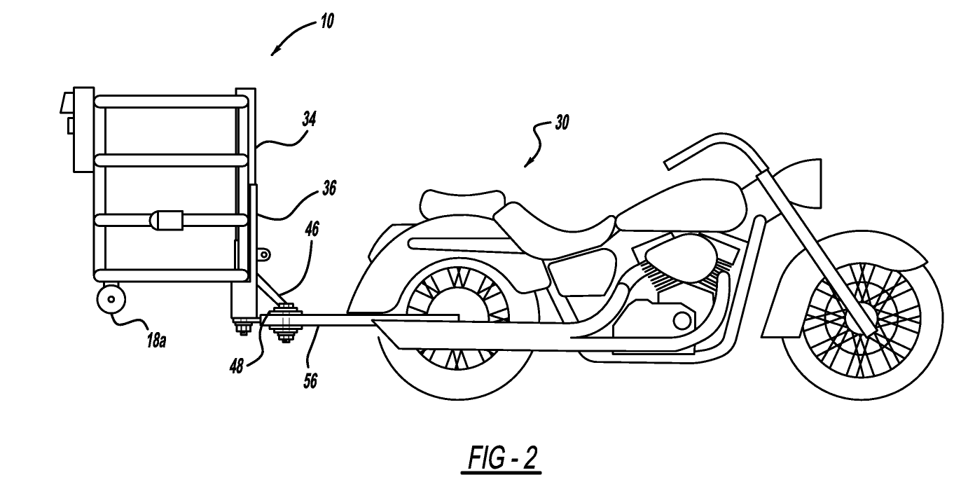

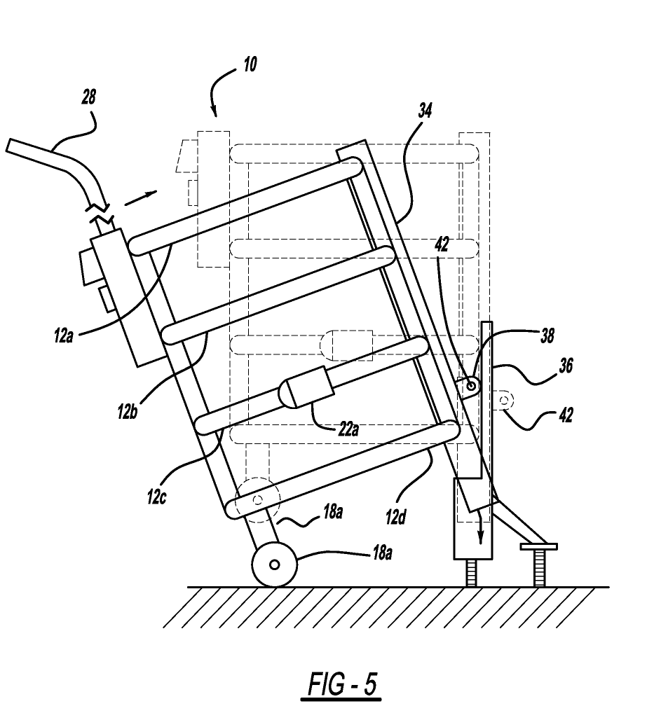

The disengageable attachment of the utility carrier 10 to a motorcycle, such as the motorcycle that is generally identified by reference numeral 30 in FIG. 2, is by way of a two-piece vertically extending linking member that is generally indicated by reference numeral 32. The two-piece vertically extending linking member 32 includes an upper link element 34, which is preferably annular in cross-section for optimum rigidity to weight characteristics, and a lower link element 36. At least an upper portion of the lower link element 36 is in the configuration of a rearwardly opening U-shape, to permit the upper link element 34 to be nested in the lower link element 36 and be removably received therein, to thereby permit the upper link element 34 which is rigidly fixed to the horizontally extending and vertically spaced annular tubular support members 12a-12d of the utility carrier 10 to be tilted in a direction away from the lower link element 36, as shown in FIG. 5. Removal of the upper link element 34 from a lower link element 36 during normal use is accomplished by providing the upper link element 34 with a forwardly extending ear 38 having an opening 42 therein, and providing the lower link element 36 with a linear slot 44 through which the forwardly extending ear 38 will project when the upper link element 34 and the lower link element 36 are joined together to mount the utility carrier 10 to the hitch for transportation of the utility carrier 10 by the motorcycle 30, as shown in FIG. 2. In such an orientation, a lock, not shown, can be secured through the opening 42 of the forwardly extending ear 38 to prevent disengagement of the upper link element 34 from the lower link element 36.

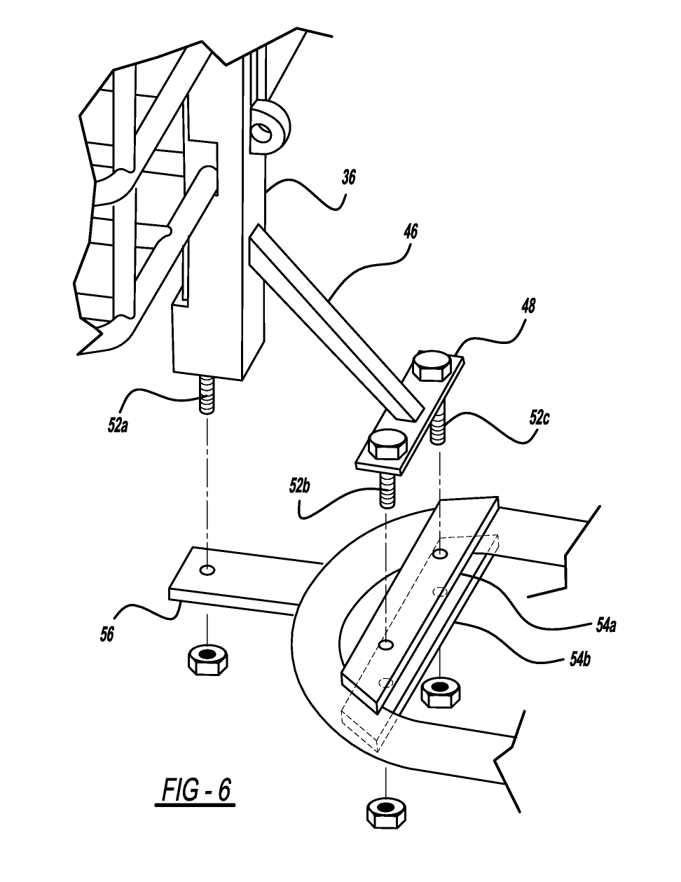

To permit the utility carrier 10 to be attached to the motorcycle 30, the lower link element 36 provides an aperture 50a located axially through its substantial closed bottom surface as shown in FIG. 1. The lower link member 36 is also provided with an outwardly and downwardly extending brace 46 with a horizontally extending bearing plate 48 attached to a lower most end of the outwardly and downwardly extending brace 46. A horizontally extending bearing plate 48 is provided with a spaced pair of apertures 50b, 50c, as shown in FIG. 1. The three apertures are to permit the lower link element 36 to be removably bolted by bolts 52a-c, as shown in FIG. 6, to a standard hitch 56 and bearing plates 54a, 54b, at the rear of the motorcycle 30. To disengage the utility carrier 10 from the motorcycle 30, all elements of the utility carrier 10, including the outwardly and downwardly extending brace 46 and the horizontally extending bearing plate 48, may be removed by removing the bolts 52a-c, as shown in FIG. 6. Alternatively, the lower link element 36 of the two-piece vertically extending linking member 32 may be left attached to the motorcycle 30, the utility carrier 10 with the upper link element 34 attached thereto may be lifted from the lower link element 36 or pivoted rearwards onto the opposed spaced pair of wheels 18a, 18b of the utility carrier 10 thereby removed from the lower link element 36 of the two-piece vertically extending linking member 32, as shown in FIG. 5.

Although the best mode contemplated by the inventor(s) for carrying out the present invention as of the filing date hereof has been shown and described herein, it will be apparent to those skilled in the art that suitable modifications, variations and equivalents may be made without departing from the scope of the invention, such scope being limited only by the terms of the following claims and the legal equivalents thereof.

What is claimed is:

1. A carrier for attachment to a motorcycle, said carrier being out of engagement with the ground with a surface on which said motorcycle is adapted to travel, said carrier comprising, in combination:
wall means defining a compartment for receiving goods;
said wall means disengageably securing said carrier to said motorcycle; and
an opposed pair of spaced wheels extending down from said carrier to permit said carrier to be used as a hand operable cart after disengagement of said carrier from said motorcycle.

2. A carrier according to claim 1 wherein said wall means comprises:
a vertically spaced plurality of horizontally extending annular members;
a horizontally extending plurality of horizontally extending members that extend between sides of one of said annular members; and
a horizontally extending plurality of vertically extending members that interconnect each of said plurality of annular members.

3. A carrier according to claim 2 wherein said horizontally extending plurality of horizontally extending members extend between said sides of a lower most one of said vertically spaced plurality of horizontally extending annular members.

4. A carrier according to claim 2 wherein each of said plurality of annular members is of tubular construction, each of said horizontally extending plurality of horizontally extending members is of tubular construction, and each of said horizontally extending plurality of vertically extending members is of tubular construction.

5. A carrier according to claim 1 further comprising an annular vertically extending member attached to said carrier above and generally in vertical alignment with said opposed pair of spaced wheels, said annular vertical extending member being adapted to receive a removable handle to permit said carrier to be used as said hand operable cart after removal of said carrier from said motorcycle.

6. A carrier according to claim 4 further comprising a handle removably attached to said annular vertically extending member to permit said carrier to be used as said hand operable cart after removal of said carrier from said motorcycle.

7. A carrier according to claim 4 wherein said vertically extending member is provided with means for attachment of a license plate to said carrier.

8. A carrier according to claim 2 wherein one of said vertically spaced horizontally extending annular members is provided with a spaced pair of rearwardly facing lights to serve as stop and turn signal lights when connected to an electrical system of said motorcycle.

9. A carrier according to claim 1 wherein said wall means is provided with a two-piece vertically extending member, said two-piece vertically extending member comprising an upper element and a lower element, at least an upper portion of said lower element disengageably receiving said upper element to permit said carrier, less said lower element, to be disengaged from said motorcycle while said lower element remains disengageably attached to said motorcycle.

10. A carrier according to claim 9 wherein said lower element is provided with a slot, said upper element is provided with a forwardly projecting ear with an aperture therein, and said forwardly projecting ear of said upper element projecting through said slot of said lower element when said upper element is received in said lower element.

11. A carrier according to claim 9 wherein said lower element is provided with an upwardly and downwardly extending brace with a horizontally extending bearing plate attached to said upwardly and downwardly extending brace and said horizontally extending bearing plate being removably attachable to a complemental bearing plate of a hitch of said carrier.

12. In combination, said carrier according to claim 1 and said motorcycle, said carrier being removably attached to said motorcycle with said spaced wheels of said carrier out of engagement with said ground when said carrier is attached to said motorcycle.
